(19) United States
(12) Patent Application Publication
(10) Pub. No.: US 2012/0221297 A1
(43) Pub. Date: Aug. 30, 2012

(54) Global Deformation for a Modeled Object

(75) Inventors: Peter Philip Lonsdale Nanson, Cambridge (GB); Richard Charles Collins, Cambridge (GB); Mark David William Harman, Cambridge (GB)

(73) Assignee: Siemens Product Lifecycle Management Software, Inc., Plano, TX (US)

(21) Appl. No.: 13/033,708

(22) Filed: Feb. 24, 2011

(51) Int. Cl. G06F 17/50

(52) U.S. Cl. 703/1

(57) ABSTRACT

A CAD system, method, and machine-readable medium. A method selecting a first plurality of points on an original surface of a 3D model and producing a first plurality of deformed points corresponding to the first plurality of points. The method includes creating a first deformed surface from the first plurality of deformed points. The method includes selecting a second plurality of points on the original surface of the model and producing a second plurality of deformed points corresponding to the second plurality of points. The method includes modifying the first deformed surface according to the second plurality of deformed points, including matching the first deformed surface to other deformed features of the model, and storing the deformed surface as part of a deformed model.

### TECHNICAL FIELD

The present disclosure is directed, in general, to systems and methods for computer-aided design, manufacturing, engineering, modeling, and visualization (individually and collectively, “CAD” and “CAD systems”), and to systems that manage product lifecycle data for manufacturers, companies, suppliers, and customers (“PLM systems”).

### BACKGROUND OF THE DISCLOSURE

Many manufactured products are first designed and modeled in CAD systems, and complex data is often managed in PLM systems. Improved systems are desirable.

### SUMMARY OF THE DISCLOSURE

Various embodiments include systems, methods, and computer program products.

A method includes selecting a first plurality of points on an original surface of a 3D model and producing a first plurality of deformed points corresponding to the first plurality of points. The method includes creating a first deformed surface from the first plurality of deformed points. The method includes selecting a second plurality of points on the original surface of the model and producing a second plurality of deformed points corresponding to the second plurality of points. The method includes modifying the first deformed surface according to the second plurality of deformed points, including matching the first deformed surface to other deformed features of the model, and storing the deformed surface as part of a deformed model.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While sonic terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIGS. 2A and 2B depict an example of the results of a deformation process in accordance with disclosed embodiments; and

FIG. 3 depicts a process in accordance with disclosed embodiments.

### DETAILED DESCRIPTION

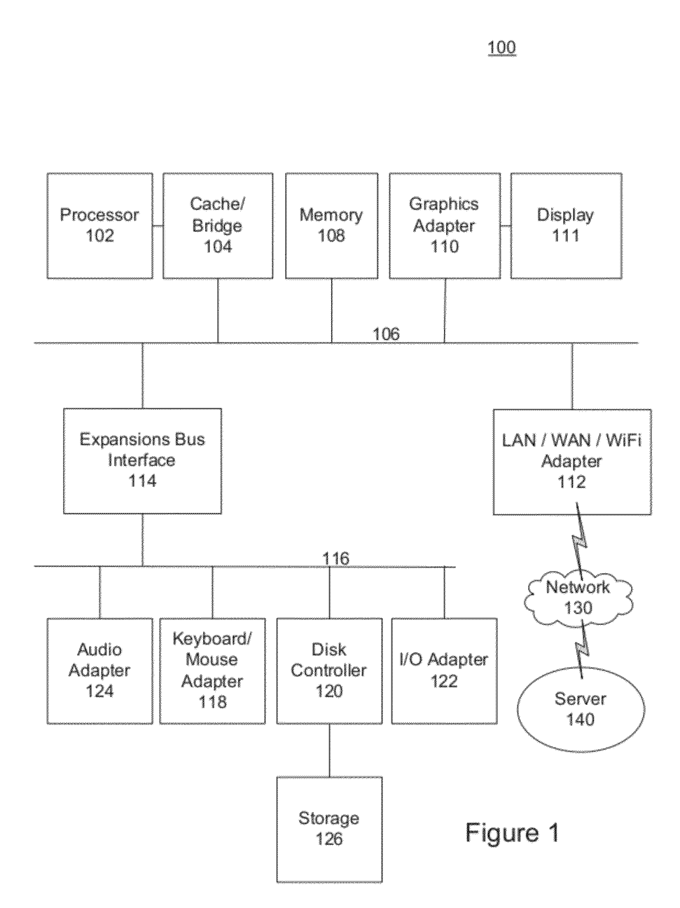

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

In solid modeling and computer-aided design, boundary representation (“B-rep” or “BREP”) represents shapes using defined “boundaries” or limits. A solid is represented as a collection of connected surface elements; the boundary is between solid and non-solid.

Boundary representation models are composed of two parts: topological elements such as faces, edges, and vertices, and geometric elements such as surfaces, curves, and points. A face is a bounded portion of a surface; an edge is a bounded piece of a curve; and a vertex lies at a point. Other common elements are the shell (a set of connected faces), the loop (a circuit of edges bounding a face), and loop-edge links (also known as winged edge links or half-edges) which are used to create the edge circuits. The edges are like the edges of a table, bounding a surface portion. A “B-surf” refers to a form of parametric surface also known as a NURBS surface or B-spline surface, known to those of skill in the art.

B-rep models are often used in CAD systems and other systems to design and model products for manufacture. There are many common cases where it is desirable to apply deformation to a B-rep model to simulate real life manufacturing or operational conditions. Examples include shrinkage of cast and molded parts on cooling, distortion of engine parts due to temperature cycles and distortion of structural parts under load cycles.

It is also highly desirable in some cases to deform only certain surfaces of a model for performance and realism reasons. For example, a turbine blade in the high temperature side of a gas turbine consists of a thin aero dynamic, shape-critical blade, and a much more substantial base which keys into the hub. The deformation of the thin blade is of greater interest and of greater magnitude due to its load and temperature cycles than the base. The effort of deforming the base may be unnecessary in many simulations.

There are many common cases where it is desirable to apply deformation to a subset of faces in a B-rep to create an aesthetic design while leaving functional and/or hidden faces unaffected. Similarly, there are cases where the change required to some faces is better represented by a transformation, taper, offset, or other operation that needs to be applied at the same time as the deformation in order to preserve topological consistency.

In some cases, it may be desirable to apply different deformation functions to different sets of surfaces in the same model.

One approach to deforming a solid model is to convert all faces of the model to b-surfs and then apply the deformation function on an individual surface-by-surface basis. The deformed surfaces are then reintegrated with the model's topological structure. This approach has numerous disadvantages, in that all design features such as blends and offset surfaces are lost so the resulting model cannot be used effectively for further modeling operations. Deforming each surface without the context of the surrounding geometry and topology can lead to poor quality surfaces, loss of accuracy and connectivity, and changes in smoothness conditions. Further, performance is sub-optimal because all faces are deformed and analytical surfaces are approximated to heavier b-surfs. In general, this process is more suitable in a post-processing paradigm rather than creating a new model for further design operations.

Disclosed embodiments include systems and methods for performing a deformation of the surfaces of a specified subset of faces in a B-rep model, while simultaneously honoring parametric and topological properties of the model as part of a general model change. In this way, the design intent and editability of the model is preserved in the deformed model, providing a distinct technical advantage over known systems. Further strengths of disclosed embodiments include the effect of topology on the fitting, and the ability to precisely calculate other operations on other faces of the model, including blends and offsets whose geometry is derived from a deformed surface.

According to various embodiments, the system iteratively fits a deformed surface to a set of points calculated according to the selected deformation. The system then checks that some selected further points lie within tolerance. If those points are not within tolerance, the system then adds further points to the set to be fitted and repeats the process until it has built a deformed surface which satisfies the tolerance constraints.

FIG. 1 depicts a block diagram of a data processing system in which an embodiment can be implemented, for example, as a CAD system configured to perform processes described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116, in the example, shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system, in accordance with an embodiment of the present disclosure, includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Various embodiments disclosed herein include systems and methods that provide the ability to deform the surfaces of a specified subset of faces in a boundary representation (B-rep) model while maintaining the parametric and topological properties of the model as part of a general model change. Various embodiments can be implemented using a single data processing system 100, or multiple data processing systems 100 that together perform the processes described herein.

Disclosed methods construct a new deformed surface to an application-defined tolerance for each selected face of a model. This is done in the context of surrounding geometry and topology to ensure high quality surfaces are produced with particular attention to connectivity and smoothness conditions where faces meet at edges.

In various embodiments, other faces that are dependent upon the deformed faces due to some geometric feature semantic, for example, blends or matched offset faces on thin-wall parts, can be re-applied as part of the deformation process, preserving the design intent of the model.

The deformation process can also be performed in combination with other modeling operations, such as transformations or tapers, to achieve results that are not possible by performing the deformation operation and other operations separately. This also allows the system to deform only those faces that are undergoing a general, non-rigid transformation, while taking advantage of accurate geometry transformation or generation for adjacent faces.

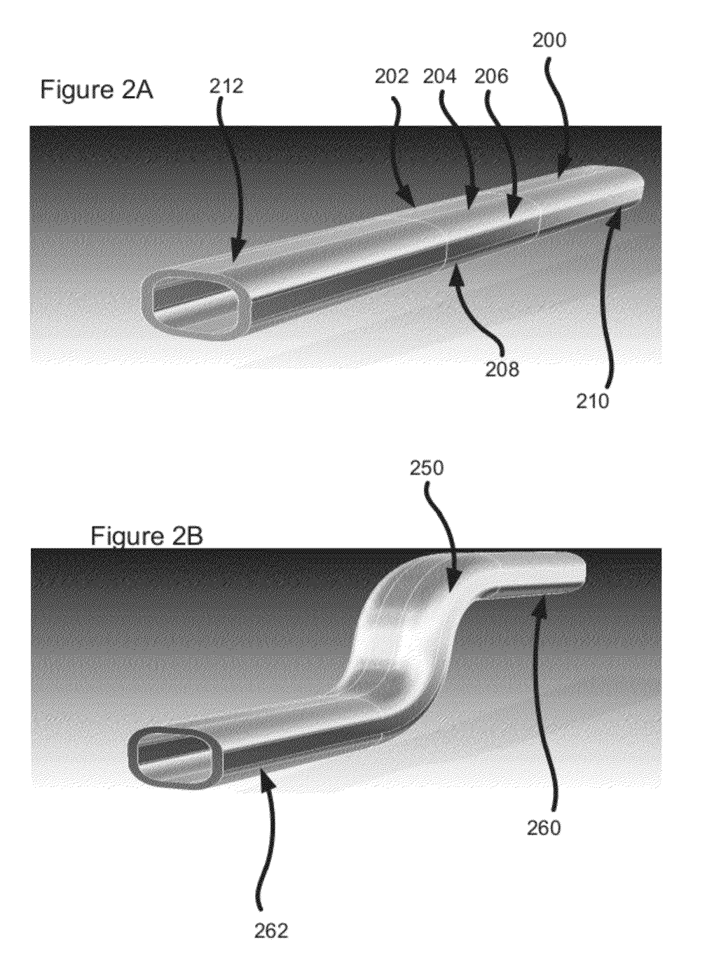

FIGS. 2A and 2B depict an example of the results of a deformation process in accordance with disclosed embodiments. FIG. 2A shows an original model 200, in this example, a thin-wall blended body. The four central external planar faces 202 (left side, hidden), 204 (top side), 206 (right side), and 208 (bottom side) are to be deformed. These faces have thin-wall partners (faces on the internal of the model) and dependent blends between the faces. The far end of the body 210 is to transform rigidly, the near end 212 is to remain fixed.

FIG. 2B shows a corresponding model 250 after transformation, in this case a thin-wall body after a deformation process performed in accordance with disclosed embodiments. As illustrated here, the connectivity and smoothness, exact blend and offset geometry has been maintained, preserving design intent. Fixed faces 262 and rigidly transformed faces 260 have preserved analytic and exact surfaces. Disclosed embodiments can maintain correspondence between different deformed surfaces and features; in this example, the system maintains a constant thickness along the model, illustrating the effectiveness of this process for global deformation of all faces.

Various embodiments use a transformation function that takes a three-dimensional space point on the surface of each specified face and in a single operation returns a corresponding point in three-dimensional space after deformation. The faces may be of solid bodies or sheet bodies or a combination of both. In some cases, this function can be called simultaneously by multiple threads.

Such a transformation function itself, for computing a deformed point, is known to those of skill in the art, and the particular function is unimportant to the processes described herein. For example, such functions are provided in commercial software packages such as the PARASOLID geometric modeling kernel, the NX CAD and PLM software product, or the SOLID EDGE CAD software product, all produced by Siemens Product Lifecycle Management Software Inc. The processes described herein work with any supplied function which can map any given three space point to its deformed equivalent. The application function can be explicit, for example, if the desired deformation was to bend or twist a portion of a body, or the result of a finite-element analysis, for example, if representing the shrinkage of a body or effect of heat on a turbine blade. Depending on the specific implementation, some functions could be supplied by a software product such as those discussed above, while others could be supplied by a user.

The process, when calling the function, may specify whether curves on edges between deformed and non-deformed fixes are deformed or remain unchanged.

One specific advantage of disclosed embodiments is that the generation of the deformed surfaces can take into account the topological requirements of the B-rep, removing a significant class of errors that typically arise during the reintegration phase of the new surfaces.

Disclosed embodiments include an iterative process of creating deformed surfaces using a transformation/deformation function, replacing the surfaces in the B-rep model and simultaneously reapplying other existing features such as blends, offsets, transformations, and tapers.

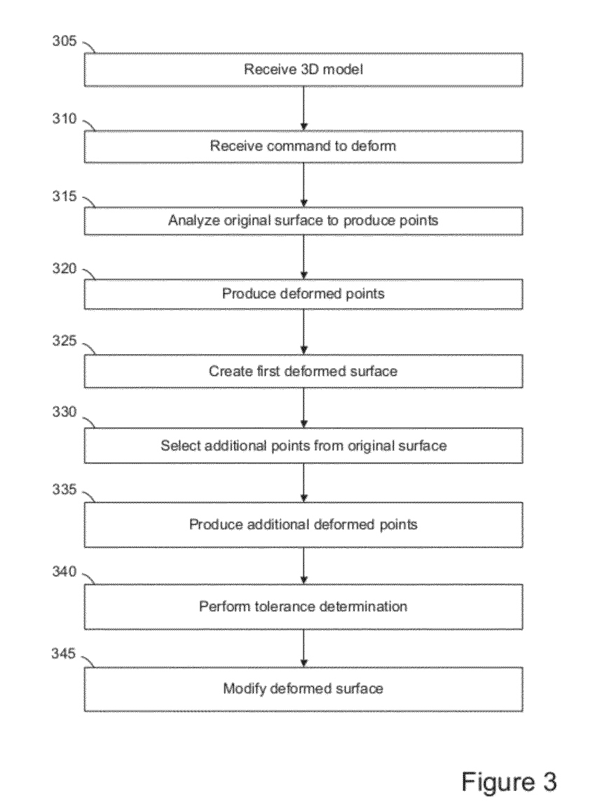

FIG. 3 depicts a flowchart of a process in accordance with disclosed embodiments. In this embodiment, a CAD system performs a deformation process of a three-dimensional model, including a calculation of the deformation surface of the model. This process can be performed by a data processing system 100, or by multiple data processing systems 100 acting together, referred to as a “CAD data processing system” herein in either case.

The system receives a 3-dimensional model (step 305). The model includes at least one original surface. Receiving, as used herein, can include loading from storage, receiving from another system, receiving through an interaction with a user, or otherwise, unless otherwise specified.

The system can receive a command to deform the original surface of the model (step 310). This can be, for example, an interaction with a user that indicates that the model is to be deformed.

The system analyzes the surface to be deformed to determine and select a first plurality of points on the original surface that are selected for deformation (step 315). The analysis may also determine many other points on the original surface that are not selected as the first plurality of points. Preferably, the first plurality of points are evenly distributed on the original surface.

The system produces a plurality of deformed points corresponding to the first plurality of points (step 320), in accordance with the deformation command. In some embodiments, this is accomplished by passing the first plurality of points to a deformation function, which returns the corresponding deformed points.

The system creates a first deformed surface, as a first approximation, from this first set of deformed points (step 325).

The system selects a second (or additional) plurality of points from the original surface (step 330). These points are preferably distributed between the points in the first plurality of points. These points may have been determined in step 315, but not selected at that point, and this step of “determining” is intended to include selecting a second plurality of previously determined points, in some embodiments.

The system produces a second plurality of deformed points corresponding to the second plurality of points (step 335). In some embodiments, this is accomplished by passing the second plurality of points to the deformation function, which returns the corresponding second plurality of deformed points.

The system performs a tolerance determination between the deformed surface and the additional plurality of deformed points (step 340). In this step, for example, the second plurality of deformed points are compared to the first deformed surface, using a predetermined tolerance, to determine points that are within tolerance and points that are outside tolerance.

The system modifies the first deformed surface according to the second plurality of deformed points (step 345). This step can include modifying the first deformed surface to include some or all of those members of the second plurality of deformed points that are outside tolerance. If other connected or related surfaces have already been or are also being deformed, then this step can also include modifying the first deformed surface to correspond to the context of surrounding geometry and topology, ensuring that high quality surfaces are produced with particular attention to connectivity and smoothness conditions where faces meet at edges. In some cases, other faces or features that are dependent upon the first deformed surface due to some geometric feature semantic, for example, blends or matched offset faces on thin-wall parts, are re-applied as part of the deformation process, preserving the design intent of the model.

Further, modifying the first deformed surface can include applying parametric and topological properties of the model as part of the deformation process. This assists in preserving the design intent and editability of the model. As part of this step, the system can adjust the fit of the surface based on an existing smooth edge or other feature, and perform the surface modification simultaneously with other “precise” operations on other faces of the model, including dependent blends and offsets.

The process can then be repeated, at step 330, until a surface is created that is entirely within tolerance. Each time the process repeats, the deformed surface is refined to include the out-of-tolerance points, so that, with each iteration, the deformed surface more closely matches an accurate deformation of the original surface, and matches any connected deformed surfaces or features. The process can be iterated until all deformed points are within the predetermined tolerance. This step can include storing the deformed surface as part of a deformed model.

The process can then be repeated, at step 315, to deform any other surfaces of the model that are associated with the first surface.

Various embodiments also include processes for avoiding unnecessary re-computation in areas of the surface that are within tolerance and to optionally maximize the sharing of deformed surfaces between faces. In various embodiments, when the original surface meets another surface smoothly at an edge, the system can maintain that smoothness by using a tighter tolerance in that local area, based on the predetermined tolerance.

It is possible that, in some cases, a satisfactory surface cannot be made for the combination of deformation function, original surface, and any surface smoothness or tolerance requirements. In this case, the system can return an error. The system can determine that the surface approximations are not converging to a satisfactory result in order to avoid unnecessary computation before returning an error code.

In various embodiments, the system can also minimize processing time by managing the size of the uvbox used (face or surface) and by using existing geometry sharing functionality where appropriate. In some embodiments, the system can recalculate the geometry and topology of faces dependent on the shape of the deforming faces, for example, blends or offsets, as part of the deformation process described herein.

In various embodiments, various steps described herein can be omitted, repeated, performed sequentially or concurrently, performed in a different order, or otherwise, as described by the claims below. For example, various steps of the processes described herein can be performed iteratively, while the deformed points in each plurality can be obtained concurrently.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art. While specific embodiments are described in terms of CAD systems and data, other embodiments can include other PLM systems and data, or other data processing systems and data, that perform processes as described herein.

It is important to note that while the disclosure includes a description in the context of a fully functional system, those skilled in the art will appreciate that at least portions of the mechanism of the present disclosure are capable of being distributed in the form of executable instructions contained within a machine-usable, computer-usable, or computer-readable medium, in any of a variety of forms, and that the present disclosure applies equally, regardless of the particular type of instruction, signal bearing medium, or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method, performed by a CAD data processing system, comprising:
(a) selecting a first plurality of points on an original surface of a three-dimensional (3D) model;
(b) producing a first plurality of deformed points corresponds corresponding to the first plurality of points;
(c) creating a first deformed surface from the first plurality of deformed points;
(d) selecting a second plurality of points on the original surface of the model;
(e) producing a second plurality of deformed points corresponding to the second plurality of points;
(f) modifying the first deformed surface according to the second plurality of deformed points, including matching the first deformed surface to other deformed features of the model; and
(g) storing the deformed surface as part of a deformed model.

2. The method of claim 1, wherein the CAD data processing system also performs a tolerance determination between the first deformed surface and the second plurality of deformed points.

3. The method of claim 1, wherein modifying the first deformed surface is performed according to one or more of the second plurality of deformed points that are out of tolerance with respect to the first deformed surface.

4. The method of claim 1, wherein steps (d)-(g) are repeated for additional points on the original surface until all deformed points are within a predetermined tolerance of the deformed surface.

5. The method of claim 1, wherein the other deformed features include at least one of faces to which other modeling operations are applied, smooth edges, dependent blends, and offsets of the model.

6. The method of claim 1, wherein the CAD data processing system receives a command to deform the original surface.

7. The method of claim 1, wherein the first plurality of points are evenly distributed on the first surface, and the second plurality of points are distributed between the first plurality of points.

8. A CAD data processing system, comprising:
a processor; and
a storage connected to be accessed by the processor, wherein the CAD data processing system is configured to perform the steps of
(a) selecting a first plurality of points on an original surface of a three-dimensional (3D) model;
(b) producing a first plurality of deformed points corresponding to the first plurality of points;
(c) creating a first deformed surface from the first plurality of deformed points;
(d) selecting a second plurality of points on the original surface of the model;
(e) producing a second plurality of deformed points corresponding to the second plurality of points;
(f) modifying the first deformed surface according to the second plurality of deformed points, including matching the first deformed surface to other deformed features of the model; and
(g) storing the deformed surface as part of a deformed model.

9. The CAD data processing system of claim 8, wherein the CAD data processing system also performs a tolerance determination between the first deformed surface and the second plurality of deformed points.

10. The CAD data processing system of claim 8, wherein modifying the first deformed surface is performed according to one or more of the second plurality of deformed points that are out of tolerance with respect to the first deformed surface.

11. The CAD data processing system of claim 8, wherein steps (d)-(g) are repeated for additional points on the original surface until all deformed points are within a predetermined tolerance of the deformed surface.

12. The CAD data processing system of claim 8, wherein the other deformed features include at least one of faces to which other modeling operations are applied, smooth edges, dependent blends, and offsets of the model.

13. The CAD data processing system of claim 8, wherein the CAD data processing system receives a command to deform the original surface.

14. The CAD data processing system of claim 8, wherein the table object is stored as a sparsely-populated table.

15. A tangible machine-readable medium encoded with executable instructions, that, when executed, cause a CAD data processing system to perform the steps of:
(a) selecting a first plurality of points on an original surface of a three-dimensional (3D) model;
(b) producing a first plurality of deformed points corresponding to the first plurality of points;
(c) creating a first deformed surface from the first plurality of deformed points;
(d) selecting a second plurality of points on the original surface of the model;
(e) producing a second plurality of deformed points corresponding to the second plurality of points;
(f) modifying the first deformed surface according to the second plurality of deformed points, including matching the first deformed surface to other deformed features of the model; and
(g) storing the deformed surface as part of a deformed model.

16. The machine-readable medium of claim 15, wherein the instructions further cause the CAD data processing system to perform a tolerance determination between the first deformed surface and the second plurality of deformed points.

17. The machine-readable medium of claim 15, wherein modifying the first deformed surface is performed according to one or more of the second plurality of deformed points that are out of tolerance with respect to the first deformed surface.

18. The machine-readable medium of claim 15, wherein steps (d)-(g) are repeated for additional points on the original surface until all deformed points are within a predetermined tolerance of the deformed surface.

19. The machine-readable medium of claim 15, wherein the other deformed features include at least one of faces to which other modeling operations are applied, smooth edges, dependent blends, and offsets of the model.

20. The machine-readable medium of claim 15, wherein the instructions further cause the CAD data processing system to system receive a command to deform the original surface.

21. The machine-readable medium of claim 15, wherein the first plurality of points are evenly distributed on the first surface, and the second plurality of points are distributed between the first plurality of points.
